(19) United States
(12) Patent Application Publication
(10) Pub. No.: US 2012/0009008 A1
(43) Pub. Date: Jan. 12, 2012

(54) Combined structural member

(75) Inventors: Kohei Hodoya, Tianjin (CN); Satoshi Kawaguchi, Takaoka-shi (JP)

(73) Assignees: Aisin Keikinzoku Kabushiki Kaisha; Aisin Seiki Kabushiki Kaisha

(21) Appl. No.: 13/067,893

(22) Filed: Jul. 5, 2011

(30) Foreign Application Priority Data
Jul. 9, 2010 (JP) 2010-157049

(51) Int. Cl. F16B 7/00

(52) U.S. Cl. 403/188

(57) ABSTRACT

A combined structural member includes a first member made of either one of aluminum and aluminum alloy and including first and second wall portions facing each other, the first member extending in a first direction, a first fitting bore formed at the first wall portion, a first attachment bore formed at the second wall portion, a second member extending in a second direction perpendicular to the first direction, a joint member including a body wall portion and a first projecting portion inserted into the first fitting bore, the joint member further including an attachment portion connected to an end portion of the second member in an engagement relationship of inserting and being inserted, a first fastener fastening the second wall portion and the first projecting portion with each other, and a second fastener fastening the end portion and the attachment portion with each other.

### CROSS REFERENCE TO RELATED APPLICATIONS

This application is based on and claims priority under 35 U.S.C. §119 to Japanese Patent Application 2010-157049, filed on Jul. 9, 2010, the entire content of which is incorporated herein by reference.

### TECHNICAL FIELD

This disclosure generally relates to a combined structural member. More particularly, the disclosure pertains to a combined structural member in which two members having different extending directions are connected to each other.

### BACKGROUND DISCUSSION

A known combined structural member is illustrated, for example, in FIG. 8. The combined structural member illustrated in FIG. 8 includes a first member 91, a second member 92, and a pair of brackets 93. The first member 91, which is made of aluminum or aluminum alloy, has substantially a rectangular cylindrical shape extending in one direction. The second member 92, which is made of aluminum or aluminum alloy, has substantially a rectangular cylindrical shape extending in the other direction perpendicular to the direction where the first member 91 extends. The pair of brackets 93, each of which is made of aluminum or aluminum alloy, is arranged to overlap a substantially T-shaped contact portion formed by the first and second members 91 and 92. The first and second members 91 and 92 are connected to the pair of brackets 93 by arc welding so as to be connected to or combined with each other by the pair of brackets 93.

In the aforementioned case, due to a lack of strength at a welding portion where the first and second members 91 and 92 are connected by means of the pair of brackets 93, durability of the combined structural member may deteriorate. In addition, a quality degradation of the combined structural member because of a thermal distortion and/or a durability decrease because of a hardness reduction of the welding portion upon the arc welding may occur. Further, welding of the two members made of aluminum or aluminum alloy is required, which leads to a cost increase.

Further, according to the aforementioned known combined structural member, positioning of the contact portion between the first and second members 91 and 92 at a time of the arc welding is not considered. Thus, the position of the contact portion may deviate, which leads to an accuracy decrease of the connection between the two members. Therefore, in order to combine or connect the two members, JP2009-280004A (hereinafter referred to as Reference 1) discloses a combined structural member (a tightening structure of a hollow member) where two members are tightened to each other by a bolt (a fastening bolt), and the like, instead of the welding. The combined structural member disclosed in Reference 1 includes a hollow member having first and second wall portions and a tightened member having a first tightened surface and a protruding portion. The first tightened surface of the tightened member is in contact with the second wall portion of the hollow member. The protruding portion protrudes from the first tightened surface towards the hollow member. A cut portion is formed at the second wall portion so that the second wall portion is in contact with the first tightened surface in a case where the hollow member is tightened to the tightened member. At this time, the protruding portion is fitted to the cut portion so that a second tightened surface formed at the protruding portion of the tightened member is in contact with the first wall portion from an inner side. The hollow member and the tightened member are tightened by means of a bolt (a fastening bolt) at a contact portion between the second wall portion and the first tightened surface and a bolt at a contact portion between the first wall portion and the second tightened surface.

Further, the combined structural member disclosed in Reference 1 includes a fixing means provided between the hollow member and the tightened member. In this case, the hollow member and the tightened member are individually and separately tightened to the fixing means so that the hollow member and the tightened member are combined or connected to each other via the fixing means.

According to Reference 1, the combined structural member is achieved by combining or connecting the tightened member having a block shape to the hollow member. At this time, however, Reference 1 does not mention whether the extending directions of the hollow member and the tightened member are different from each other.

A need thus exists for a combined structural member which is not susceptible to the drawback mentioned above.

### SUMMARY

According to an aspect of this disclosure, a combined structural member includes a first member made of either one of aluminum and aluminum alloy and formed into a cylindrical shape while including first and second wall portions facing each other, the first member extending in a first direction, a first fitting bore formed at the first wall portion, a first attachment bore formed at the second wall portion and being concentric with the first fitting bore, a second member extending in a second direction perpendicular to the first direction in which the first member extends, a joint member including a body wall portion being in contact with an outer wall surface of the first wall portion and a first projecting portion formed to project at the body wall portion and inserted into the first fitting bore to make contact with an inner wall surface of the second wall portion at a peripheral edge of the first attachment bore, the joint member further including an attachment portion connected to an end portion of the second member facing the first member in an engagement relationship of inserting and being inserted, a first fastener inserted into the first attachment bore to fasten the second wall portion and the first projecting portion with each other, and a second fastener fastening the end portion and the attachment portion with each other.

According to another aspect of this disclosure, a combined structural member includes a first member made of either one of aluminum and aluminum alloy and formed into a cylindrical shape extending in a first direction, a second member made of either one of aluminum and aluminum alloy and formed into the cylindrical shape extending in a second direction perpendicular to the first direction where the first member extends, a fitting recess portion formed to be cut at the first member and facing an end portion of the second member facing the first member, and a joint member including an outer fitting portion fitted to the fitting recess portion and an inner fitting portion fitted to an inner wall surface of the end portion, the joint member including an outer wall surface arranged between the first member and the second member to be coplanar with the first member and the second member along a plane defined by the first direction and the second direction where the first member and the second member extend, a portion between the outer wall surface and the first and second members being welded.

According to a further aspect of this disclosure, a combined structural member includes a first member made of either one of aluminum and aluminum alloy and formed into a cylindrical shape extending in a first direction, a second member made of either one of aluminum and aluminum alloy and extending in a second direction perpendicular to the first direction where the first member extends, a fitting recess portion formed to be cut at the first member and facing an end portion of the second member facing the first member, and a fitting piece formed to project at the end portion and fitted to the fitting recess portion, the fitting piece including an outer wall surface being coplanar with the first member along a plane defined by the first direction and the second direction where the first member and the second member extend, a portion between the outer wall surface and the first member being welded.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exploded perspective view of a combined structural member according to a first embodiment disclosed here;

FIG. 2 is a cross sectional view of the combined structural member according to the first embodiment;

FIG. 3 is a perspective view schematically illustrating a battery frame according to the first embodiment;

FIG. 4 is an exploded perspective view of a combined structural member according to a second embodiment disclosed here;

FIG. 5 is a cross-sectional view of the combined structural member according to the second embodiment;

FIG. 6A is a perspective view of a combined structural member according to a third embodiment disclosed here;

FIG. 6B is a cross-sectional view of the combined structural member according to the third embodiment;

FIG. 7A is a perspective view of a combined structural member according to a fourth embodiment disclosed here;

FIG. 7B is a cross-sectional view of the combined structural member according to the fourth embodiment; and

FIG. 8 is a perspective view of a known combined structural member.

### DETAILED DESCRIPTION

### First Embodiment

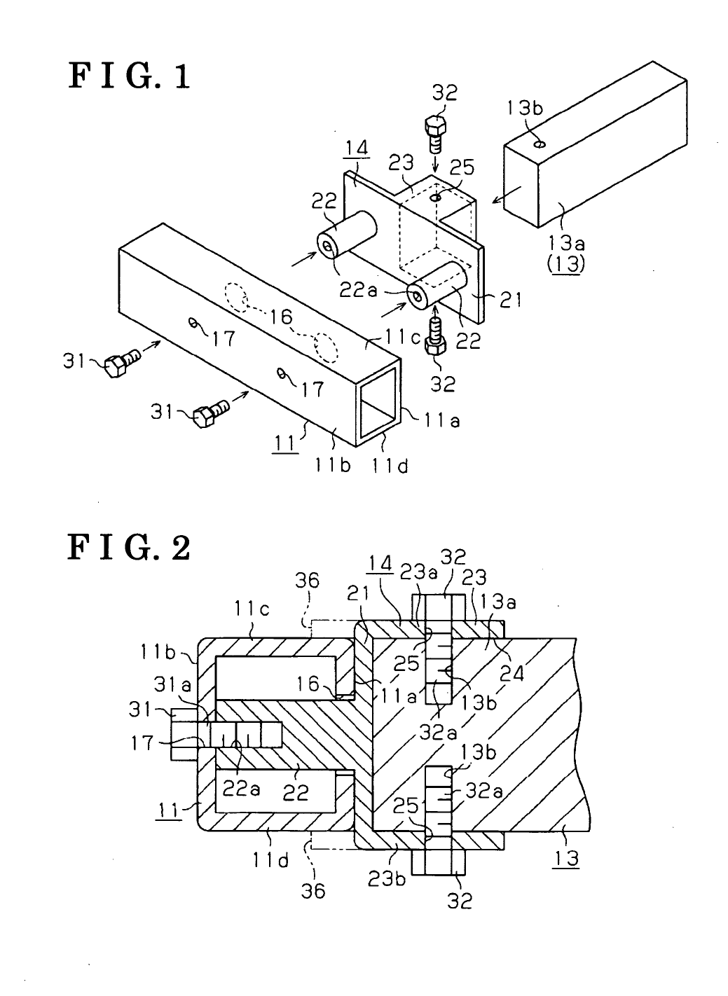

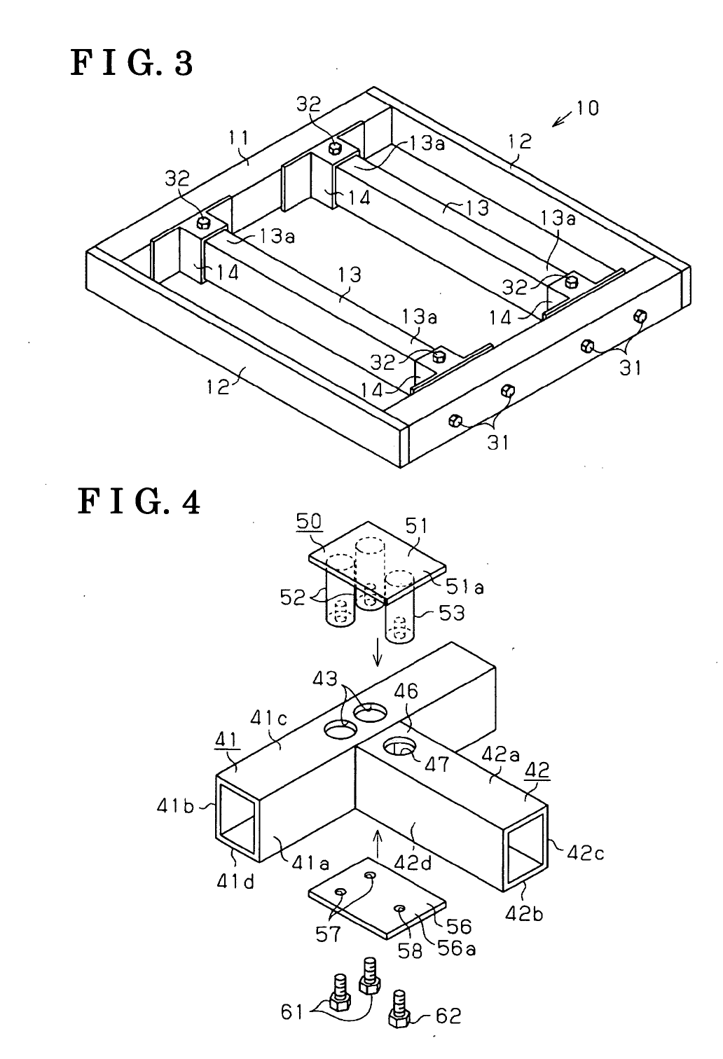

A first embodiment will be explained with reference to FIGS. 1 to 3. FIG. 3 is a perspective view schematically illustrating a battery frame 10 at which a high voltage battery for an electric vehicle, a hybrid vehicle, or the like is mounted. As illustrated in FIG. 3, the battery frame 10 is substantially formed into a rectangular frame shape while including a pair of first frames 11 extending in parallel to each other and each serving as a first member, and a pair of frames 12 connected to respective ends of the first frames 11 so as to be arranged between the pair of first frames 11. The first frames 11 extend in one direction (i.e., a first direction) as illustrated in FIG. 3.

The battery frame 10 also includes multiple second frames 13 (according to the present embodiment, two second frames 13) each serving as a second member. The second frames 13 extend in a direction (i.e., a second direction) perpendicular to the first direction where the first frames 11 extend so as to be arranged side by side in the first direction while having an interval. The second frames 13 are connected to the first frames 11 at end portions 13a via joint portions 14 respectively each serving as a joint member.

Next, a combined structural member according to the first embodiment obtained by the first and second frames 11 and 13, and the joint portions 14 provided therebetween will be explained below. As illustrated in FIGS. 1 and 2, each of the first frames 11 is made of an aluminum or aluminum alloy extruded material. The first frame 11 includes side wall portions 11a and 11b serving as first and second wall portions facing in the second direction where the second frame 13 extends while having an interval. The first frame 11 also includes a cover wall portion 11c connecting ends of the side wall portions 11a and 11b at one side (i.e., at an upper side in FIG. 2), and a bottom wall portion 11d connecting ends of the side wall portions 11a and 11b at the other side (i.e., at a lower side in FIG. 2). The first frame 11 is thus substantially formed into a rectangular cylindrical shape. Multiple circular-shaped fitting bores (according to the present embodiment, two fitting bores) 16 each serving as a first fitting bore are formed at the side wall portion 11a facing the second frame 13. The fitting bores 16 are arranged at both sides of a position on an extension line of the second frame 13 in the second direction where the second frame 13 extends. In addition, the fitting bores 16 are arranged side by side in the first direction where the first frame 11 (the side wall portion 11a) extends. In addition, multiple circular-shaped attachment bores 17 (according to the present embodiment, two attachment bores 17), each serving as a first attachment bore, are formed at the side wall portion 11b that is positioned away from the second frame 13 so as to be concentric with the respective fitting bores 16.

Each of the second frames 13 is substantially formed into a rectangular column shape by aluminum or aluminum alloy. A pair of internal thread portions 13b is formed at one side surface (i.e., at an upper side surface in FIG. 2A) and the other side surface (i.e., at a lower side surface in FIG. 2A), respectively, of the end portion 13a of each of the second frames 13. Specifically, the internal thread portion 13b formed at the one side surface is formed to be pierced therefrom downwardly in a vertical direction in FIG. 2 while the internal thread portion 13b formed at the other side surface is formed to be pierced therefrom upwardly in the vertical direction in FIG. 2 so that the internal thread portions 13b are concentric with each other.

Each of the joint portions 14 is made of aluminum or an aluminum alloy casting material. The joint portion 14 includes a body wall portion 21 substantially having a plate shape and extending in a longitudinal direction of the first frame 11. In addition, the joint portion 14 includes multiple projecting portions 22 (according to the present embodiment, two projecting portions 22) each serving as a first projecting portion. The projecting portions 22 each substantially having a column shape project along centerlines of the facing fitting bores 16 and the attachment bores 17 in a state to be formed at the body wall portion 21 at both sides in the longitudinal direction thereof. The joint portion 14 further includes a fitting portion 23 substantially having a rectangular cylindrical shape and formed at a center portion of the body wall portion 21 in the longitudinal direction thereof so as to project towards the end portion 13a of the second frame 13. The fitting portion 23 serves as an attachment portion and a contact wall portion.

Each of the projecting portions 22 projecting in the second direction where the second frame 13 extends is inserted into the corresponding fitting bore 16 so as to make contact with an inner wall surface of the side wall portion 11b at a peripheral edge of the attachment bore 17. At this time, a projection length of each of the projecting portions 22 is specified so that the body wall portion 21 makes contact with an outer wall surface of the side wall portion 11a. An internal thread portion 22a is formed at each of the projecting portions 22 so as to be pierced from an end surface thereof while being concentric with the corresponding attachment bore 17. The internal thread portions 22a of the projecting portions 22 are meshed with external thread portions 31a formed at first bolts 31 which are inserted into the respective attachment bores 17 and each of which serves as a first fastener to thereby fasten the side wall portion 11b and the projecting portions 22 with each other. As a result, the first frame 11 and the joint portion 14 are combined with or connected to each other.

The fitting portion 23 includes a fitting hole 24 substantially having a rectangular shape and substantially matching a lateral cross section of the second frame 13. The end portion 13a of the second frame 13 is inserted into and fitted to the fitting hole 24 in a state where the second frame 13 is in contact with the body wall portion 21 in the second direction where the second frame 13 extends. That is, the fitting portion 23 is connected to the end portion 13a in an engagement relationship of inserting and being inserted (specifically, the end portion 13a is inserted into the fitting portion 23). The fitting portion 23 (specifically, the fitting hole 24) is in contact with an outer wall surface (i.e., four outer surfaces) of the end portion 13a along the second direction where the second frame 13 extends. Circular-shaped bolt insertion bores 25 are formed at a pair of fitting wall portions of the fitting portion 23, i.e., fitting wall portions 23a and 23b (see FIG. 2), respectively, so as to face each other in the vertical direction. Each of the bolt insertion bores 25 is arranged to be concentric with the internal thread portion 13b in a state where the end portion 13a is inserted into and fitted to the fitting hole 24. The internal thread portions 13b are meshed with external thread portions 32a formed at second bolts 32 which are inserted into the respective bolt insertion bores 25 and each of which serves as a second fastener to thereby fasten the end portion 13a and the fitting wall portions 23a and 23b of the fitting portion 23 with each other. As a result, the second frame 13 and the joint portion 14 are combined with or connected to each other.

As mentioned above, the first frames 11 and the second frames 13 are connected to one another by means of the joint portions 14. According to the aforementioned first embodiment, following effects may be obtained.

(1) The first frame 11 and the joint portion 14 are connected to or combined with each other by the first bolts 31 that are inserted into the respective attachment bores 17 so as to fasten the side wall portion 11b with the projecting portions 22. In addition, the second frame 13 and the joint portion 14 are connected to or combined with each other by the second bolts 32 that are inserted into the respective bolt insertion bores 25 so as to fasten the fitting portion 23 with the end portion 13a. Accordingly, the first and second frames 11 and 13 extending in the different directions are connected to or combined with each other via the joint portion 14 without requiring the welding.

Even when the shape of the first frame 11 and/or the second frame 13 is changed so as to connect the first and second frames 11 and 13 via the joint portion 14, for example, the first and second frames 11 and 13 are still connected to or combined with each other because the joint portion 14 absorbs such change of the shape of the first frame 11 and/or the second frame 13. Consequently, a design flexibility of the combined structural member may increase.

(2) The end portion 13a is inserted into and fitted to the fitting portion 23 in a state where the second frame 13 is in contact with the body wall portion 21 in the second direction where the second frame 13 extends. Thus, a load applied to the first frame 11 in a direction where the projecting portion 22 extends (i.e., the extending direction of the second frame 13) is securely transmitted to the second frame 13 between the body wall portion 21 and the end portion 13a in a state where the load is supported by the projecting portions 22.

(3) According to the first embodiment, the welding for connecting or combining the first and second frames 11 and 13 is not required. Therefore, the deterioration in durability of the combined structural member because of a lack of strength at a welding portion is avoided. Further, the deterioration in quality of the combined structural member because of a thermal distortion, the decrease in durability of the welding portion because of a hardness reduction of the welding portion upon welding, and the like are avoided. Furthermore, the welding of members made of aluminum or aluminum alloy is not required, which leads to a cost reduction.

(4) According to the first embodiment, the first frame 11 is formed into a cylindrical shape by aluminum or aluminum alloy to thereby obtain a light weight of the first frame 11. The load applied to the first frame 11 in the direction where the projecting portion 22 projects is supported by the projecting portion 22, which may restrain the deformation of the first frame 11.

(5) According to the first embodiment, the second frame 13 is in contact with the fitting portion 23 via the outer wall surface of the end portion 13a. Thus, in a case where a moment of force is applied so as to rotate the second frame 13 in any direction relative to the end portion 13a, the second frame 13 is supported by the fitting portion 23. Thus, an inclination of the second frame 13 relative to the end portion 13a may be restrained.

As mentioned above, JP2009-280004A (Reference 1) discloses the combined structural member where the block-shaped fastened member is connected to or combined with the hollow member. Even when the fastened member includes an extending direction thereof, a method for restraining an inclination of the fastened member is not mentioned in Reference 1, which may result in that the extending direction of the fastened member may correspond to a direction where the fastening bolts are arranged, i.e., an extending direction of the hollow member. Thus, a concept to connect or combine the two members having the different extending directions (i.e., the first and second frames 11 and 13) as in the present embodiment may not be obtained according to Reference 1.

### Second Embodiment

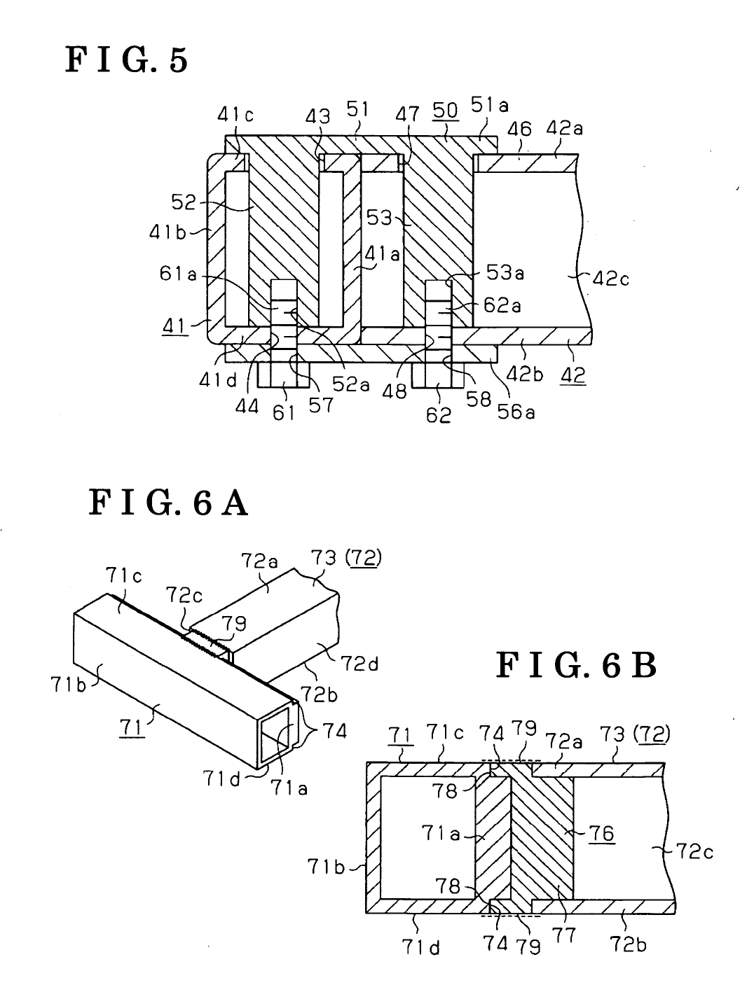

A second embodiment will be explained with reference to FIGS. 4 and 5. As illustrated in FIGS. 4 and 5, a first frame 41 serving as the first member is made of the aluminum or aluminum alloy extruded material. The first frame 41 is substantially formed into a rectangular cylindrical shape while including a pair of side wall portions 41a and 41b, a cover wall portion 41c, and a bottom wall portion 41d. The side wall portions 41a and 41b face each other while having an interval therebetween in a direction where a second frame 42 serving as the second member extends (i.e., the second direction). The cover wall portion 41c and the bottom wall portion 41d, serving as the first and second wall portions, connect end portions of the side wall portions 41a and 41b at one side (i.e., an upper side in FIG. 5) and connect end portions of the side wall portions 41a and 41b at the other side (i.e., a lower side in FIG. 5), respectively. The cover wall portion 41c and the bottom wall portion 41d face each other in the vertical direction in FIG. 5 (i.e., in a direction substantially perpendicular to a plane defined by the extending directions of the first and second frames 41 and 42). Multiple circular-shaped first fitting bores 43 (according to the present embodiment, two first fitting bores 43) each serving as the first fitting bore are formed at the cover wall portion 41c arranged at the upper side in FIG. 5. Specifically, the first fitting bores 43 are arranged at both sides of a position on an extension line of the second frame 42 in the extending direction thereof. Thus, the first fitting bores 43 are arranged side by side in the extending direction (i.e., the first direction) of the first frame 41. In addition, multiple circular-shaped first attachment bores (according to the present embodiment, two first attachment bores) 44 each serving as the first attachment bore and being concentric with the respective first fitting bores 43 are formed at the bottom wall portion 41d arranged at a lower side in FIG. 5.

The second frame 42 is made of the aluminum or aluminum alloy extruded material. The second frame 42 is substantially formed into a rectangular cylindrical shape while including a pair of attachment wall portions 42a and 42b serving as first and second attachment wall portions, and a pair of side wall portions 42c and 42d. The attachment wall portions 42a and 42b face each other in a direction where the cover wall portion 41c and the bottom wall portion 41d of the first frame 41 face each other in a state where the attachment wall portions 42a and 42b are formed to be coplanar with the cover wall portion 41c and the bottom wall portion 41d respectively. The side wall portion 42c connects respective end portions of the attachment wall portions 42a and 42b at one side (i.e., at an upper right side in FIG. 4) while the side wall portion 42d connects respective end portions of the attachment wall portions 42a and 42b at the other side (i.e., at a lower left side in FIG. 4). A circular-shaped second fitting bore 47 serving as a second fitting bore is formed at an end portion 46 of the second frame 42 facing the first frame 41. In addition, a circular-shaped second attachment bore 48 serving as a second attachment bore is formed at the attachment wall portion 42b being coplanar with the bottom wall portion 41d so as to be concentric with the second fitting bore 47. The second frame 42 is in contact with the first frame 41 (specifically, the side wall portion 41a) in the extending direction of the second frame 42.

A joint portion 50 serving as the joint member is made of the aluminum or aluminum alloy casting material. The joint portion 50 includes a body wall portion 51 substantially having a plate shape while extending on a plane defined by the extending directions of the first and second frames 41 and 42. The joint portion 50 also includes multiple first projecting portions (according to the present embodiment, two first projecting portions) 52 each substantially having a column shape, and a second projecting portion 53 substantially having a column shape and serving as the attachment portion. Each of the first projecting portions 52 is formed to project along center lines of the corresponding first fitting bore 43 and the first attachment bore 44. In addition, the second projecting portion 53 is formed to project along center lines of the second fitting bore 47 and the second attachment bore 48.

Each of the first projecting portions 52 projects in a direction perpendicular to the plane that is defined by the extending directions of the first and second frames 41 and 42. The first projecting portion 52 is inserted into the first fitting bore 43 so as to make contact with an inner wall surface of the bottom wall portion 41d at a peripheral edge of the first attachment bore 44. At this time, a projection length of the first projecting portion 52 is specified so that the body wall portion 51 makes contact with an outer wall surface of the cover wall portion 41c. In the same way, the second projecting portion 53 projects in a direction perpendicular to the plane that is defined by the extending directions of the first and second frames 41 and 42. The second projecting portion 53 is inserted into the second fitting bore 47 so as to make contact with an inner wall surface of the attachment wall portion 42b at a peripheral edge of the second attachment bore 48. That is, the second projecting portion 53 is connected to the end portion 46 (the second fitting bore 47) in an engagement relationship of inserting and being inserted (specifically, the second projecting portion 53 is inserted into the end portion 46). At this time, a projection length of the second projecting portion 53 is specified so that the body wall portion 51 makes contact with an outer wall surface of the attachment wall portion 42a. Accordingly, the body wall portion 51 is in contact with the outer wall surfaces of the cover wall portion 41c and the attachment wall portion 42a while extending across a boundary portion where the first and second frames 41 and 42 make contact with each other. The body wall portion 51 includes a contact wall portion 51a at a contact range relative to the outer wall surface of the attachment wall portion 42a. Further, an internal thread portion 52a is formed at each of the first projecting portions 52 so as to be pierced from an end surface thereof. The internal thread portion 52a is concentric with the first attachment bore 44. In the same way, an internal thread portion 53a is formed at the second projecting portion 53 so as to be pierced from an end surface thereof. The internal thread portion 53a is concentric with the attachment bore 48.

A holding member 56 made of aluminum or aluminum alloy and substantially having a plate shape is arranged so as to overlap the bottom wall portion 41d and the attachment wall portion 42b while extending on the plane defined by the extending directions of the first and second frames 41 and 42. The holding member 56 is in contact with outer wall surfaces of the bottom wall portion 41d and the attachment wall portion 42b while extending across the boundary portion where the first and second frames 41 and 42 make contact with each other. The holding member 56 includes a contact wall portion 56a at a contact range relative to the outer wall surface of the attachment wall portion 42b.

Circular-shaped first bolt insertion bores 57 are formed at the holding member 56 so as to be concentric with the corresponding first attachment bores 44 (and the corresponding internal thread portions 52a). The internal thread portions 52a are meshed with external thread portions 61a formed at respective first bolts 61 each serving as the first fastener and each inserted into the corresponding first bolt insertion bore 57 and the corresponding first attachment bore 44 to thereby fasten the bottom wall portion 41d in addition to the holding member 56, and the first projecting portions 52. As a result, the first frame 41 and the joint portion 50 are connected to or combined with each other.

In addition, a circular-shaped second bolt insertion bore 58 is formed at the holding member 56 so as to be concentric with the second attachment bore 48 (and the internal thread portion 53a). The internal thread portion 53a is meshed with an external thread portion 62a formed at a second bolt 62 serving as the second fastener and inserted into the second bolt insertion bore 58 and the second attachment bore 48 to thereby fasten the attachment wall portion 42b in addition to the holding member 56, and the second projecting portion 53. As a result, the second frame 42 and the joint portion 50 are connected to or combined with each other.

Accordingly, the first frames 41 and the second frames 42 are connected to or combined with one another via the joint portions 50 (and the holding members 56) in the aforementioned manner.

According to the aforementioned second embodiment, the following effects may be obtained in addition to the effects (1), (3), and (4) of the first embodiment mentioned above.

1. A load applied to the cylindrical-shaped second frame 42 in the extending direction of the second projecting portion 53 is supported by the second projecting portion 53, thereby restraining the deformation of the second frame 42.

2. The body wall portion 51 is in contact with the outer wall surfaces of the cover wall portion 41c and the attachment wall portion 42a while extending across the boundary portion where the first frame 41 and the second frame 42 make contact with each other. In addition, the holding member 56 is in contact with the outer wall surfaces of the bottom wall portion 41d and the attachment wall portion 42b while extending across the boundary portion where the first frame 41 and the second frame 42 make contact with each other. Thus, the first frame 41 and the second frame 42 are sandwiched and held by the body wall portion 51 and the holding member 56 in a direction where the cover wall portion 41c and the bottom wall portion 41d, and the like face each other in a state where the body wall portion 51 and the holding member 56 each extend across the aforementioned boundary portion. As a result, the first frame 41 and the second frame 42 are securely and firmly held at the aforementioned boundary portion.

3. According to the second embodiment, the second frame 42 is in contact with the contact wall portion 51a at an outer wall surface of the end portion 46 of the attachment wall portion 42a. Thus, the second frame 42 is supported by the contact wall portion 51a in a case where a moment of force is applied so as to rotate the second frame 42 in a thickness direction of the body wall portion 51 relative to the end portion 46. In the same way, the second frame 42 is in contact with the contact wall portion 56a at the outer wall surface of the end portion 46 of the attachment wall portion 42b. Thus, the second frame 42 is supported by the contact wall portion 56a in a case where the moment of force is applied so as to rotate the second frame 42 in a thickness direction of the holding member 56 relative to the end portion 46. Therefore, the inclination of the second frame 42 relative to the end portion 46 may be restrained.

### Third Embodiment

A third embodiment will be explained with reference to FIGS. 6A and 6B. A first frame 71 serving as the first member is made of the aluminum or aluminum alloy extruded material. The first frame 71 is substantially formed into a rectangular cylindrical shape while including a pair of side wall portions 71a and 71b, a cover wall portion 71c, and a bottom wall portion 71d. The side wall portions 71a and 71b face each other while having an interval therebetween in an extending direction of a second frame 72 serving as the second member. The cover wall portion 71c connects end portions of the side wall portions 71a and 71b at one side (i.e., at an upper side in FIG. 6A) while the bottom wall portion 71d connects end portions of the side wall portions 71a and 71b at the other side (i.e., at a lower side in FIG. 6A). Then, fitting recess portions 74 each substantially having a rectangular shape in a cross section are formed at corner portions between the side wall portion 71a and the cover wall portion 71c and between the side wall portion 71a and the bottom wall portion 71d respectively. The fitting recess portions 74 face an end portion 73 formed at the second frame 72 facing the first frame 71. Each of the fitting recess portions 74 extends in a longitudinal direction of the first frame 71 over an entire length thereof.

The second frame 72 is made of the aluminum or aluminum alloy extruded material. The second frame 72 is substantially formed into a rectangular cylindrical shape while including a cover wall portion 72a, a bottom wall portion 72b, and a pair of side wall portions 72c and 72d. The cover wall portion 72a and the bottom wall portion 72b face each other in a direction where the cover wall portion 71c and the bottom wall portion 71d of the first frame 71 face each other. The side wall portion 72c connects end portions of the cover wall portion 72a and the bottom wall portion 72b at one side (i.e., an upper left side in FIG. 6) while the side wall portion 72d connects end portions of the cover wall portion 72a and the bottom wall portion 72b at the other side (i.e., a lower right side in FIG. 6). The cover wall portion 72a and the bottom wall portion 72b are formed so that outer surfaces thereof are coplanar with the cover wall portion 71c and the bottom wall portion 71d of the first frame 71 respectively.

A joint portion 76 serving as the joint member is made of the aluminum or aluminum alloy casting material. The joint portion 76 includes an inner fitting portion 77 and a pair of outer fitting portions 78. The inner fitting portion 77, substantially formed into a rectangular column shape, has an outer shape similar to an inner wall shape of the end portion 73 of the second frame 72. The outer fitting portions 78 extend to the respective fitting recess portions 74 from end portions of the inner fitting portion 77 facing the first frame 71. The inner fitting portion 77 is fitted to an inner wall surface of the end portion 73 in a state where the inner fitting portion 77 makes contact with an outer side surface of the side wall portion 71a. The outer fitting portions 78 are fitted to the respective fitting recess portions 74 in a state where the outer fitting portions 78 make contact with end surfaces of the cover wall portion 72a and the bottom wall portion 72b of the second frame 72. The outer fitting portions 78 include outer wall surfaces 79 coplanar with the cover wall portions 71c and 72a and the bottom wall portions 71d and 72b respectively along a plane defined by the extending directions (i.e., the first and second directions) of the first and second frames 71 and 72.

Portions between the outer wall surface 79 and the cover wall portions 71c and 72a, and portions between the outer wall surface 79 and the bottom wall portions 71d and 72b are welded by friction stir welding, for example. In FIGS. 6A and 6B, welding ranges by the friction stir welding are schematically indicated by multiple “x” and dashed lines respectively for descriptive purpose. The joint portion 76 is connected to or combined with the first frame 71 in a state where the outer fitting portions 78 are fitted to the respective fitting recess portions 74, and the outer wall surfaces 79 and both of the cover wall portion 71c and the bottom wall portion 71d are welded. In addition, the joint portion 76 is connected to or combined with the second frame 72 in a state where the inner fitting portion 77 is fitted to the inner wall surface of the end portion 73, and the outer wall surfaces 79 and both of the cover wall portion 72a and the bottom wall portion 72b are welded. Accordingly, the first and second frames 71 and 72 having the different extending directions from each other are connected by means of the joint portion 76.

In a case where the outer wall surfaces 79 and both of the first and second frames 71 and 72 are welded, the joint portion 76 is temporary assembled on the first and second frames 71 and 72 in a state where the outer fitting portions 78 are fitted to the respective fitting recess portions 74 and the inner fitting portion 77 is fitted to the inner wall surface of the end portion 73. Thus, the first and second frames 71 and 72 are connected to or combined with each other while a positional deviation of the first frame 71 or the second frame 72 relative to the joint portion 76 is being restrained.

According to the third embodiment, the following effects may be obtained. (1) In a case where the outer wall surfaces 79 are welded to both the first and second frames 71 and 72, the joint portion 76 is temporary assembled on the first and second frames 71 and 72 in a state where the outer fitting portions 78 are fitted to the respective fitting recess portions 74 and the inner fitting portion 77 is fitted to the inner wall surface of the end portion 73. Thus, the first and second frames 71 and 72 are connected to or combined with each other while the positional deviation of the first frame 71 and/or the second frame 72 relative to the joint portion 76 upon welding is restrained. The connection accuracy of the first and second frames 71 and 72 via the joint portion 76 may be enhanced accordingly.

(2) According to the third embodiment, the outer fitting portions 78 are fitted to the respective fitting recess portions 74 in a state where the outer fitting portions 78 are in contact with the end surface of the second frame 72. Thus, the load applied to the first frame 71 in the extending direction of the second frame 72, for example, is securely transmitted to the second frame 72 via the joint portion 76 (specifically, the outer fitting portions 78).

### Fourth Embodiment

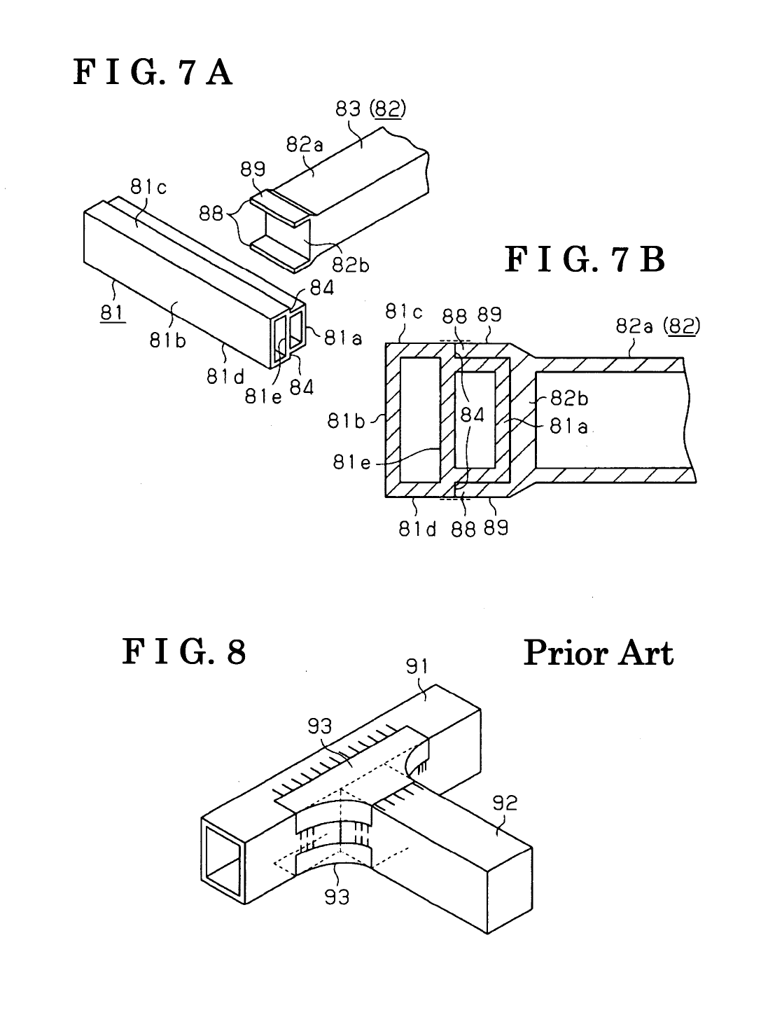

A fourth embodiment will be explained with reference to FIGS. 7A and 7B. A first frame 81 serving as the first member is made of the aluminum or aluminum alloy extruded material. The first frame 81 includes a pair of side wall portions 81a and 81b, a cover wall portion 81c, a bottom wall portion 81d, and an intermediate rib portion 81e, thereby being formed into a cylindrical shape divided into two portions. The side wall portions 81a and 81b face each other while having an interval therebetween in an extending direction of a second frame 82 serving as the second member. The cover wall portion 81c connects end portions of the side wall portions 81a and 81b at one side (i.e., an upper side in FIG. 7A) while the bottom wall portion 81d connects end portions of the side wall portions 81a and 81b at the other side (i.e., a lower side in FIG. 7B). The intermediate rib portion 81e divides a cylindrical portion between the side wall portions 81a and 81b into two. Fitting recess portions 84, each substantially having a rectangular shape in a cross section, are formed at corners between the side wall portion 81a and the cover wall portion 81c and between the side wall portion 81a and the bottom wall portion 81d. The fitting recess portions 84 face an end portion 83 of the second frame 82 facing the first frame 81. Each of the fitting recess portions 84 extends in a longitudinal direction of the first frame 81 over an entire length thereof.

The second frame 82 is made of the aluminum or aluminum alloy casting material, for example. The second frame 82 includes a body portion 82a substantially having a rectangular column shape, and a closing wall portion 82b closing an opening end of the body portion 82a facing the first frame 81. The second frame 82 also includes a pair of fitting pieces 88 extending to the fitting recess portions 84 from respective ends of the closing wall portion 82b at one side (i.e., an upper side in FIG. 7A) and the other side (i.e., a lower side in FIG. 7A). The fitting pieces 88 are fitted to the respective fitting recess portions 84. The fitting pieces 88 include outer wall surfaces 89 coplanar with the cover wall portion 81c and the bottom wall portion 81d respectively along a plane that is defined by the extending directions (i.e., the first and second directions) of the first and second frames 81 and 82. The outer wall surfaces 89 and both of the cover wall portion 81c and the bottom wall portion 81d are welded by the friction stir welding, for example. In FIG. 7B, welding regions by the friction stir welding are schematically indicated by dashed lines for descriptive purpose. The second frame 82 is connected to or combined with the first frame 81 in a state where the fitting pieces 88 are fitted to the respective fitting recess portions 84 and the outer wall surfaces 89 and both of the cover wall portion 81c and the bottom wall portion 81d are welded. Accordingly, the first and second frames 81 and 82 having the different extending directions from each other are connected to or combined with each other.

In a case where the outer wall surfaces 89 and both of the cover wall portion 81c and the bottom wall portion 81d of the first frame 81 are welded, the second frame 82 is temporary assembled on the first frame 81 because of the fitting pieces 88 fitted to the respective fitting recess portions 84. Thus, the first and second frames 81 and 82 are connected to or combined with each other while the positional deviation of the second frame 82 relative to the first frame 81 is restrained upon welding.

According to the aforementioned fourth embodiment, the following effect may be obtained. In a case where the outer wall surfaces 89 and the first frame 81 are welded, the second frame 82 is temporary assembled on the first frame 81 because of the fitting pieces 88 fitted to the respective fitting recess portions 84. Thus, the first and second frames 81 and 82 are connected to or combined with each other while the positional deviation of the second frame 82 relative to the first frame 81 is restrained upon welding. As a result, the connection accuracy of the first and second frames 81 and 82 may be enhanced.

The aforementioned embodiments may be changed or modified as below. As illustrated by chain double-dashed lines in FIG. 2, according to the first embodiment, a pair of holding pieces 36 may project in the extending direction of the second frame 13 from the body wall portion 21 along the cover wall portion 11c and the bottom wall portion 11d respectively. In this case, the first frame 11 is sandwiched and held by the holding pieces 36 of the joint portion 14, thereby restraining a positional deviation or looseness of the first frame 11 relative to the joint portion 14.

According to the first embodiment, the second frame 13 may be formed into a rectangular cylindrical shape. In the second embodiment, the number of second projecting portion 53, the second fitting bore 47, or the like is an example and may be appropriately changed.

In the first and second embodiments, the number of projecting portions 22, 52, and the fitting bores 16, 43 is an example and may be appropriately changed. In the first and second embodiments, as long as the first frame 11, 41 includes a pair of wall portions facing each other, the first frame 11, 41 may be formed into a polygon cylindrical shape equal to or more than a pentagon, or into a partially circular cylindrical shape.

According to the aforementioned first to fourth embodiments, as long as the first frame and the second frame extend in the directions so as to intersect with each other, an angle (an inclination angle) between the first frame and the second frame is not specifically determined. In addition, the first frame and/or the second frame may not be necessarily linear along the extending direction thereof. The first frame and/or the second frame may partially or fully bend relative to the extending direction thereof.

The aforementioned first to fourth embodiments are applicable to a bumper apparatus for a vehicle including a bumper reinforcement serving as the first frame and a crush box serving as the second frame. In this case, when the configurations of the first embodiment are specifically applied, the load applied to the bumper reinforcement (the first frame 11) in the projecting direction of the projecting portion 22 is supported by the projecting portion 22, thereby restraining the deformation of the bumper reinforcement. Then, the deformation of the bumper reinforcement may be restrained until the crush box is crushed.

The aforementioned first to fourth embodiments may be applicable to the other exterior parts for a vehicle, components for other than the vehicle, and the like. The first to fourth embodiments may be applicable at least to the two members, having the different extending directions from each other, being connected to or combined with each other.

According to the aforementioned first and second embodiments, the two members having the different extending directions are connected to or combined with each other without requiring the welding. In addition, according to the aforementioned third and fourth embodiments, the two members having the different extending directions are connected to or combined with each other in a state where the positional deviation is restrained that may occur at a time of welding.

According to the aforementioned first and second embodiments, the combined structural member includes the first frame 11, 41 made of either one of aluminum and aluminum alloy and formed into a cylindrical shape while including the side wall portions 11a, 11b/the cover wall portion 41c and the bottom wall portion 41d facing each other, the first frame 11, 41 extending in the first direction, the fitting bore 16, 43 formed at the side wall portion 11a/the cover wall portion 41c, the attachment bore 17, 44 formed at the side wall portion 11b/the bottom wall portion 41d and being concentric with the fitting bore 16, 43, the second frame 13, 42 extending in the second direction perpendicular to the first direction in which the first frame 11, 41 extends, the joint portion 14, 50 including the body wall portion 21, 51 being in contact with the outer wall surface of the side wall portion 11a/the cover wall portion 41c and the projecting portion 22, 52 formed to project at the body wall portion 21, 51 and inserted into the fitting bore 16, 43 to make contact with the inner wall surface of the side wall portion 11b/the bottom wall portion 41d at a peripheral edge of the attachment bore 17, 44, the joint portion 14, 50 further including the fitting portion 23/the projecting portion 53 connected to the end portion 13a, 46 of the second frame 13, 42 facing the first frame 11, 41 in an engagement relationship of inserting and being inserted, the first fastener 31, 61 inserted into the attachment bore 17, 44 to fasten the side wall portion 11b/the bottom wall portion 41d and the first projecting portion 22, 52 with each other, and the second fastener 32, 62 fastening the end portion 13a, 46 and the fitting portion 23/the projecting portion 53 with each other.

Accordingly, the first frame 11, 41 and the joint portion 14, 50 are connected to or combined with each other in a state where the first bolts 31, 61 are inserted into the attachment bores 17, 44 so that the wall portion 11b, 41d and the projecting portions 22, 52 are tightened to each other. In addition, the second frame 13, 42 and the joint portion 14, 50 are connected to or combined with each other in a state where the second bolt 32, 62 causes the end portion 13a, 46 to be tightened to the fitting portion 23/the projecting portion 53. Accordingly, the first frame 11, 41 and the second frame 13, 42 are connected to or combined with each other via the joint portion 14, 50 without requiring the welding.

According to the aforementioned first embodiment, the joint portion 14 includes the fitting portion 23 making contact with the outer wall surface of the end portion 13a in the second direction where the second frame 13 extends.

Accordingly, in a case where the moment of force is applied so as to rotate the second frame 13 relative to the end portion 13a, the second frame 13 is supported by the fitting portion 23. The inclination of the second frame 13 relative to the end portion 13a is restrained accordingly.

According to the aforementioned first embodiment, the projecting portion 22 projects in the second direction where the second frame 13 extends. The attachment (fitting) portion 23 includes the fitting portion where the end portion 13a is fitted and inserted in a state where the second frame 13 makes contact with the body wall portion 21 in the second direction where the second frame 13 extends. The second fastener 32 fastens the fitting portion 23 and the end portion 13a in a direction perpendicular to the second direction where the second frame 13 extends.

Accordingly, the end portion 13a is inserted into and fitted to the fitting portion 23 (specifically, the fitting hole 24) in a state where the second frame 13 is in contact with the body wall portion 21 in the extending direction of the second frame 13. Thus, the load applied to the first frame 11 in the projecting direction of the projecting portion 22 towards the second frame 13 is securely transmitted to the second frame 13 between the body wall portion 21 and the end portion 13a while the load is being supported by the projecting portion 22.

According to the aforementioned first embodiment, the joint portion 14 includes the pair of holding pieces 36 projecting from the body wall portion 21 in the second direction to sandwich and hold the first frame 11.

Accordingly, the first frame 11 is sandwiched and held between the pair of holding pieces 36 of the joint portion 14 to thereby restrain the positional deviation and looseness of the first frame 11 relative to the joint portion 14.

According to the aforementioned second embodiment, the cover wall portion 41c and the bottom wall portion 41d face each other in a direction perpendicular to the plane that is defined by the first and second directions where the first and second frames 41 and 42 extend. The second frame 42 is in contact with the first frame 41 in the second direction where the second frame 42 extends and is formed into a cylindrical shape while including the pair of attachment wall portions 42a and 42b facing in a direction where the cover wall portion 41c and the bottom wall portion 41d face each other, the second frame 42 including the second fitting bore 47 formed at the attachment wall portion 42a facing the cover wall portion 41c where the fitting bore 43 is formed, and the attachment bore 48 formed at the attachment wall portion 42b facing the bottom wall portion 41d where the attachment bore 44 is formed, the attachment bore 48 being concentric with the fitting bore 47. The body wall portion 51 is in contact with the outer wall surface of the attachment wall portion 42a where the fitting bore 47 is formed. The second attachment portion 53 includes the second projecting portion 53 formed to project at the body wall portion 51 to be inserted into the fitting bore 47, the second projecting portion 53 being in contact with the inner wall surface of the attachment wall portion 42b at a peripheral edge of the attachment bore 48. The second fastener 62 is inserted into the attachment bore 48 to fasten the attachment wall portion 42b and the second projecting portion 53 with each other.

Accordingly, in a case where the load is applied to the second frame 42 in the projecting direction of the second projecting portion 53, the load is supported by the second projecting portion 53 to thereby restrain the deformation of the second frame 42.

According to the aforementioned second embodiment, the combined structural member further includes the holding member 56 arranged to overlap the bottom wall portion 41d where the attachment bore 44 is formed and the attachment wall portion 42b where the attachment bore 48 is formed, the holding member 56 being fastened together with the bottom wall portion 41d and the first projecting portion 52 by the first fastener 61 while being fastened together with the attachment wall portion 42b and the second projecting portion 53 by the second fastener 62.

Accordingly, the body wall portion 51 is in contact with the outer wall surface of the cover wall portion 41c where the fitting bore 43 is formed and with the outer wall surface of the attachment wall portion 42a where the fitting bore 47 is formed in a state where the body wall portion 51 extends across the boundary portion where the first and second frames 41 and 42 are in contact with each other. On the other hand, the holding member 56 is in contact with the outer wall surface of the bottom wall portion 41d where the attachment bore 44 is formed and with the outer wall surface of the attachment wall portion 42b where the attachment bore 48 is formed in a state where the holding member 56 extends across the boundary portion where the first and second frames 41 and 42 are in contact with each other. Thus, the first and second frames 41 and 42 are sandwiched and held between the body wall portion 51 and the holding member 56 in a direction where the cover wall portion 41c and the bottom wall portion 41d, and the like face each other in a state where the body wall portion 51 and the holding member 56 each extend across the aforementioned boundary portion. Consequently, the first and second frames 41 and 42 are firmly held at the aforementioned boundary portion.

According to the aforementioned third embodiment, the combined structural member includes the first frame 71 made of either one of aluminum and aluminum alloy and formed into a cylindrical shape extending in the first direction, the second frame 72 made of either one of aluminum and aluminum alloy and formed into the cylindrical shape extending in the second direction perpendicular to the first direction where the first frame 71 extends, the fitting recess portion 74 formed to be cut at the first frame 71 and facing the end portion 73 of the second frame 72 facing the first frame 71, and the joint portion 76 including the outer fitting portion 78 fitted to the fitting recess portion 74 and the inner fitting portion 77 fitted to the inner wall surface of the end portion 73, the joint portion 76 including the outer wall surface 79 arranged between the first frame 71 and the second frame 72 to be coplanar with the first frame 71 and the second frame 72 along the plane defined by the first direction and the second direction where the first frame 71 and the second frame 72 extend, a portion between the outer wall surface 79 and the first and second frames 71 and 72 being welded.

Accordingly, the joint portion 76 is connected to or combined with the first frame 71 because of the outer fitting portions 78 fitted to the respective fitting recess portions 74 and the welding between the outer wall surface 79 and the first frame 71. In addition, the joint portion 76 is connected to or combined with the second frame 72 because of the inner fitting portion 77 fitted to the inner wall surface of the end portion 73 and the welding between the outer wall surface 79 and the second frame 72. Thus, the first and second frames 71 and 72 having the different extending directions from each other are connected to or combined with each other via the joint portion 76. In this case, at a time of welding between the outer wall surface 79 and the first frame 71 and between the outer wall surface 79 and the second frame 72, the joint portion 76 is temporary assembled on the first and second frames 71 and 72 because of the outer fitting portions 78 fitted to the respective fitting recess portions 74 and the inner fitting portion 77 fitted to the inner wall surface of the end portion 73. As a result, the first and second frames 71 and 72 are connected to or combined with each other in a state where the positional deviation of the first frame 71 and/or the second frame 72 relative to the joint portion 76 is restrained upon the welding.

According to the aforementioned fourth embodiment, the combined structural member includes the first frame 81 made of either one of aluminum and aluminum alloy and formed into a cylindrical shape extending in the first direction, the second frame 82 made of either one of aluminum and aluminum alloy and extending in the second direction perpendicular to the first direction where the first frame 81 extends, the fitting recess portion 84 formed to be cut at the first frame 81 and facing the end portion 83 of the second frame 82 facing the first frame 81, and the fitting piece 88 formed to project at the end portion 83 and fitted to the fitting recess portion 84, the fitting piece 88 including the outer wall surface 89 being coplanar with the first frame 81 along the plane defined by the first direction and the second direction where the first frame 81 and the second frame 82 extend, a portion between the outer wall surface 89 and the first frame 81 being welded.

Accordingly, the second frame 82 is connected to or combined with the first frame 81 having the extending direction being different from that of the second frame 82 because of the fitting pieces 88 fitted to the respective fitting recess portions 84 and the welding between the outer wall surfaces 89 and the first frame 81. In this case, at a time of welding between the outer wall surfaces 89 and the first frame 81, the second frame 82 is temporary assembled on the first frame 81 by the fitting pieces fitted to the respective fitting recess portions 84. Therefore, the first and second frames 81 and 82 are connected to or combined with each other while the positional deviation of the second frame 82 relative to the first frame 81 is restrained.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A combined structural member, comprising:
a first member made of either one of aluminum and aluminum alloy and formed into a cylindrical shape while including first and second wall portions facing each other, the first member extending in a first direction;
a first fitting bore formed at the first wall portion;
a first attachment bore formed at the second wall portion and being concentric with the first fitting bore;
a second member extending in a second direction perpendicular to the first direction in which the first member extends;
a joint member including a body wall portion being in contact with an outer wall surface of the first wall portion and a first projecting portion formed to project at the body wall portion and inserted into the first fitting bore to make contact with an inner wall surface of the second wall portion at a peripheral edge of the first attachment bore, the joint member further including an attachment portion connected to an end portion of the second member facing the first member in an engagement relationship of inserting and being inserted;
a first fastener inserted into the first attachment bore to fasten the second wall portion and the first projecting portion with each other; and
a second fastener fastening the end portion and the attachment portion with each other.

2. The combined structural member according to claim 1, wherein the joint member includes a contact wall portion making contact with an outer wall surface of the end portion in the second direction where the second member extends.

3. The combined structural member according to claim 1, wherein the first projecting portion projects in the second direction where the second member extends,
the attachment portion includes a fitting portion where the end portion is fitted and inserted in a state where the second member makes contact with the body wall portion in the second direction where the second member extends, and
the second fastener fastens the fitting portion and the end portion in a direction perpendicular to the second direction where the second member extends.

4. The combined structural member according to claim 2, wherein the first projecting portion projects in the second direction where the second member extends,
the attachment portion includes a fitting portion where the end portion is fitted and inserted in a state where the second member makes contact with the body wall portion in the second direction where the second member extends, and
the second fastener fastens the fitting portion and the end portion in a direction perpendicular to the second direction where the second member extends.

5. The combined structural member according to claim 4, wherein the joint member includes a pair of holding pieces projecting from the body wall portion in the second direction to sandwich and hold the first member.

6. The combined structural member according to claim 1, wherein the first and second wall portions face each other in a direction perpendicular to a plane that is defined by the first and second directions where the first and second members extend,
the second member is in contact with the first member in the second direction where the second member extends and is formed into a cylindrical shape while including first and second attachment wall portions facing in a direction where the first and second wall portions face each other, the second member including a second fitting bore formed at the first attachment wall portion facing the first wall portion where the first fitting bore is formed, and a second attachment bore formed at the second attachment wall portion facing the second wall portion where the first attachment bore is formed, the second attachment bore being concentric with the second fitting bore,
the body wall portion is in contact with an outer wall surface of the first attachment wall portion where the second fitting bore is formed,
the attachment portion includes a second projecting portion formed to project at the body wall portion to be inserted into the second fitting bore, the second projecting portion being in contact with an inner wall surface of the second attachment wall portion at a peripheral edge of the second attachment bore, and
the second fastener is inserted into the second attachment bore to fasten the second attachment wall portion and the second projecting portion with each other.

7. The combined structural member according to claim 2, wherein the first and second wall portions face each other in a direction perpendicular to a plane that is defined by the first and second directions where the first and second members extend,
the second member is in contact with the first member in the second direction where the second member extends and is formed into a cylindrical shape while including first and second attachment wall portions facing in a direction where the first and second wall portions face each other, the second member including a second fitting bore formed at the first attachment wall portion facing the first wall portion where the first fitting bore is formed, and a second attachment bore formed at the second attachment wall portion facing the second wall portion where the first attachment bore is formed, the second attachment bore being concentric with the second fitting bore,
the body wall portion is in contact with an outer wall surface of the first attachment wall portion where the second fitting bore is formed,
the attachment portion includes a second projecting portion formed to project at the body wall portion to be inserted into the second fitting bore, the second projecting portion being in contact with an inner wall surface of the second attachment wall portion at a peripheral edge of the second attachment bore, and
the second fastener is inserted into the second attachment bore to fasten the second attachment wall portion and the second projecting portion with each other.

8. The combined structural member according to claim 6, further comprising a holding member arranged to overlap the second wall portion where the first attachment bore is formed and the second attachment wall portion where the second attachment bore is formed, the holding member being fastened together with the second wall portion and the first projecting portion by the first fastener while being fastened together with the second attachment wall portion and the second projecting portion by the second fastener.

9. A combined structural member comprising:
a first member made of either one of aluminum and aluminum alloy and formed into a cylindrical shape extending in a first direction;
a second member made of either one of aluminum and aluminum alloy and formed into the cylindrical shape extending in a second direction perpendicular to the first direction where the first member extends;
a fitting recess portion formed to be cut at the first member and facing an end portion of the second member facing the first member; and
a joint member including an outer fitting portion fitted to the fitting recess portion and an inner fitting portion fitted to an inner wall surface of the end portion, the joint member including an outer wall surface arranged between the first member and the second member to be coplanar with the first member and the second member along a plane defined by the first direction and the second direction where the first member and the second member extend, a portion between the outer wall surface and the first and second members being welded.

10. A combined structural member comprising:
a first member made of either one of aluminum and aluminum alloy and formed into a cylindrical shape extending in a first direction;
a second member made of either one of aluminum and aluminum alloy and extending in a second direction perpendicular to the first direction where the first member extends;
a fitting recess portion formed to be cut at the first member and facing an end portion of the second member facing the first member; and
a fitting piece formed to project at the end portion and fitted to the fitting recess portion, the fitting piece including an outer wall surface being coplanar with the first member along a plane defined by the first direction and the second direction where the first member and the second member extend, a portion between the outer wall surface and the first member being welded.
